(19) United States
(12) Patent Application Publication
(10) Pub. No.: US 2005/0194928 A1
(43) Pub. Date: Sep. 8, 2005

(54) Power tool capable of charging a rechargeable battery unit that includes at least a standard-sized battery cell

(76) Inventor: Ching-Wen Hou, Taichung City (TW)

Correspondence Address: BROOKS KUSHMAN P.C., 1000 TOWN CENTER, TWENTY-SECOND FLOOR, SOUTHFIELD, MI, 48075, US

(21) Appl. No.: 10/795,592

(22) Filed: Mar. 8, 2004

(51) Int. Cl. H02J 7/00

(52) U.S. Cl. 320/114

(57) ABSTRACT

A power tool includes a tool housing, a motor device, and a power module. The tool housing accommodates removably a rechargeable battery unit. The motor device is mounted in the tool housing. The power module is coupled to the motor device for supplying electric power thereto, is responsive to an external power signal for permitting charging of the rechargeable battery unit simultaneous with supply of the electric power to the motor device when the rechargeable battery unit is disposed in the tool housing, and permits supply of the electric power to the motor device through the rechargeable battery unit in the absence of the external power signal.

### BACKGROUND OF THE INVENTION

1. Field of the Invention

The invention relates to a power tool, more particularly to a power tool capable of charging a rechargeable battery unit that includes at least a standard-sized battery cell.

2. Description of the Related Art

Conventional power tools are disadvantageous in that the functionality of the same is limited. It is desirable to provide a power tool, which includes additional functions to result in added value so as to enhance competitiveness in the marketplace.

### SUMMARY OF THE INVENTION

Therefore, the object of the present invention is to provide a power tool capable of charging a rechargeable battery that includes at least a standard-sized battery cell.

According to the present invention, a power tool comprises a tool housing, a motor device, a tool bit holder, and a power module. The tool housing is provided with a battery chamber adapted to accommodate removably a rechargeable battery unit that includes at least a standard-sized battery cell. The motor device is mounted in the tool housing. The tool bit holder is coupled to and is driven by the motor device. The power module is coupled to the motor device for supplying electric power thereto, and includes a battery contact set and a power circuit. The battery contact set is provided in the battery chamber and is adapted to connect electrically with the rechargeable battery unit. The power circuit is connected electrically to the battery contact set, is responsive to an external power signal for permitting charging of the rechargeable battery unit through the battery contact set simultaneous with supply of the electric power to the motor device when the rechargeable battery unit is disposed in the battery chamber, and permits supply of the electric power to the motor device through the rechargeable battery unit in the absence of the external power signal.

### BRIEF DESCRIPTION OF THE DRAWING

Other features and advantages of the present invention will become apparent in the following detailed description of the preferred embodiment with reference to the accompanying drawing, of which:

FIG. 1 is a schematic circuit block diagram of the preferred embodiment of a power tool according to the present invention;

FIG. 2 is a perspective view of the preferred embodiment;

FIG. 3 is a schematic view of the preferred embodiment; and

FIG. 4 is a perspective view to illustrate a rechargeable battery unit when disposed in a battery chamber of the preferred embodiment.

### DETAILED DESCRIPTION OF THE PREFERRED EMBODIMENT

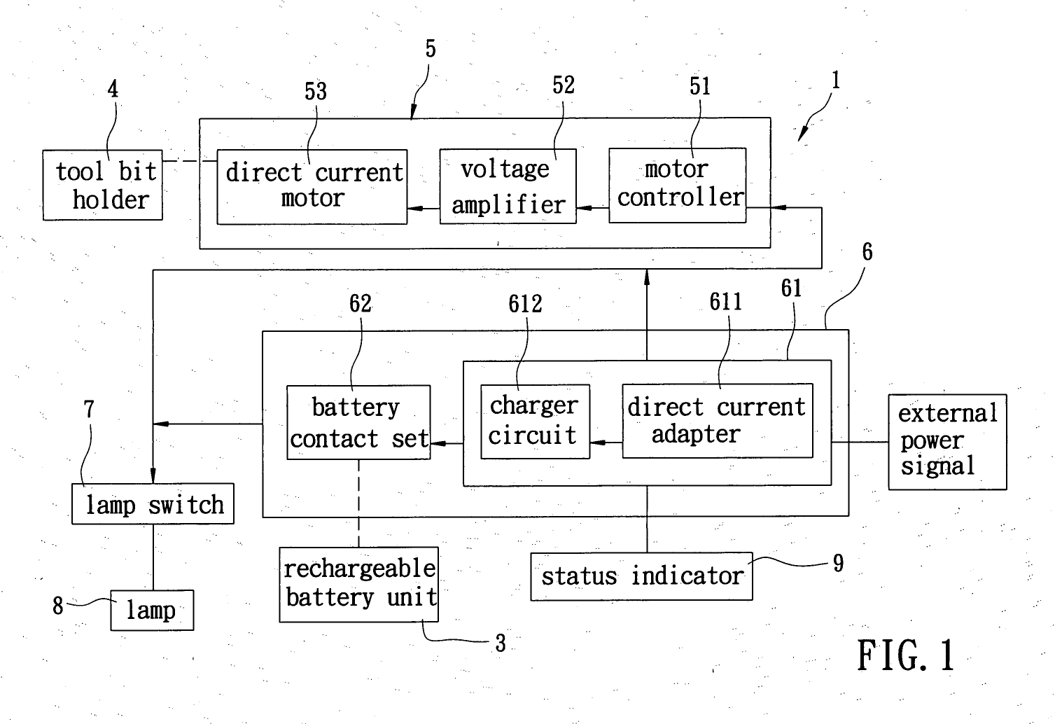

Referring to FIGS. 1 to 4, the preferred embodiment of a power tool 1 according to this invention is shown to include a tool housing 2, a motor device 5, a tool bit holder 4, and a power module 6.

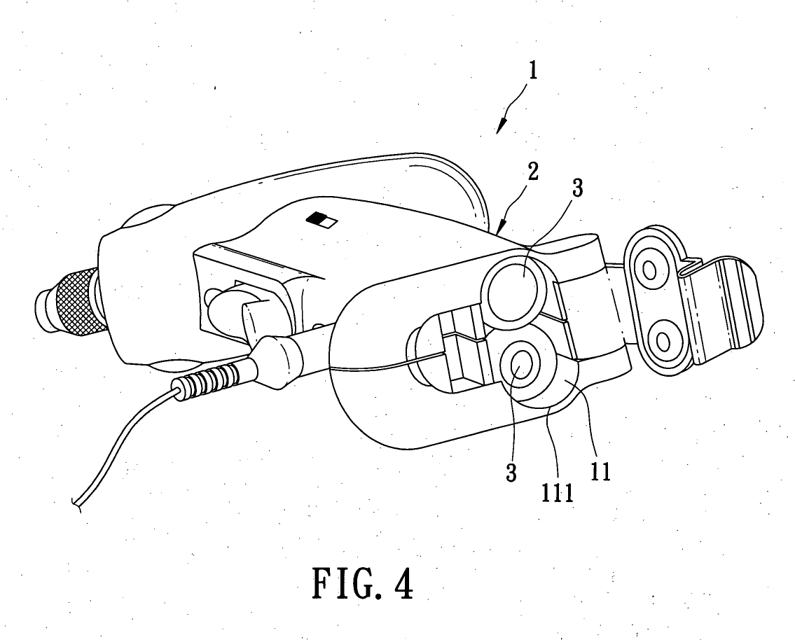

The tool housing 2 has a hollow top portion 21, and a bottom portion 22, in the form of a handle. The bottom portion 22 of the tool housing 2 defines therein a battery chamber 11 that has an open end 111, as best shown in FIG. 4. In this embodiment, the battery chamber 11 is adapted to accommodate removably a rechargeable battery unit 3. Preferably, the rechargeable battery unit 3 includes four triple AAA standard-sized battery cells. Apparently, the rechargeable battery unit 3 may be used for other consumer electronic products, such as a radio, a digital camera, a remote controller, a telephone, etc. Furthermore, the rechargeable battery unit 3 may be recharged by a separate general battery charger (not shown). However, since the power tool 1 of this invention can be used to recharge the rechargeable battery unit 3 (to be described herein after), the general battery charger is superfluous in view of the built-in charging function of the power tool 1.

The motor device 5 is mounted in the top portion 21 of the tool housing 2. In this embodiment, the motor device 5 includes a direct current motor 53, a voltage amplifier 52 coupled electrically to the direct current motor 53, and a motor controller 51 coupled electrically to the voltage amplifier 52. The motor controller 51 includes a known trigger mechanism 511 operable so as to control direction of rotation of the direct current motor 53.

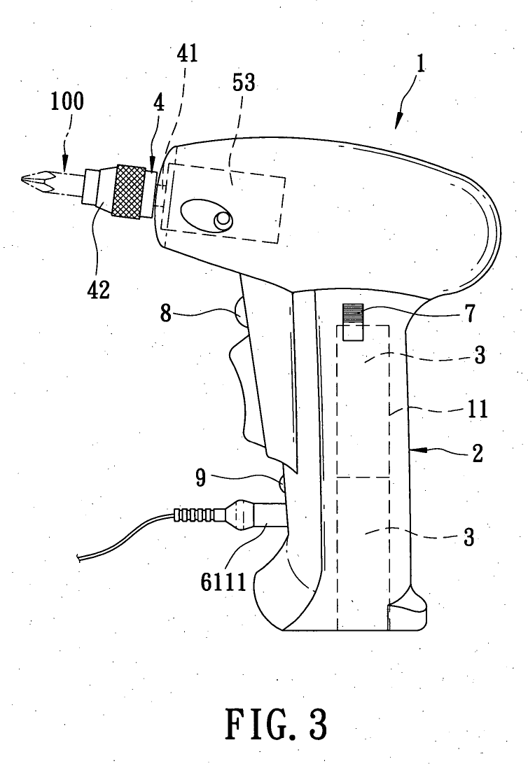

The tool bit holder 4 is coupled to and is driven by the direct current motor 53 of the motor device 5, in a known manner. As best shown in FIG. 3, the tool bit holder 4 has a first end 41 coupled co-rotatably to the direct current motor 53, and a second end provided with a chuck 42 for securing a tool bit 100.

The power module 6 is coupled to the motor device 5 for supplying electric power thereto, and includes a battery contact set 62 and a power circuit 61. The battery contact set 62 is provided in the battery chamber 11 and is adapted to connect electrically with the rechargeable battery unit 3. The power circuit 61 is responsive to an external power signal for permitting charging of the rechargeable battery unit 3 through the battery contact set 62 simultaneous with supply of the electric power to the motor device 5 when the rechargeable battery unit 3 is disposed in the battery chamber 11. Furthermore, the power circuit 61 permits supply of the electric power to the motor device 5 through the rechargeable battery unit 3 in the absence of the external power signal.

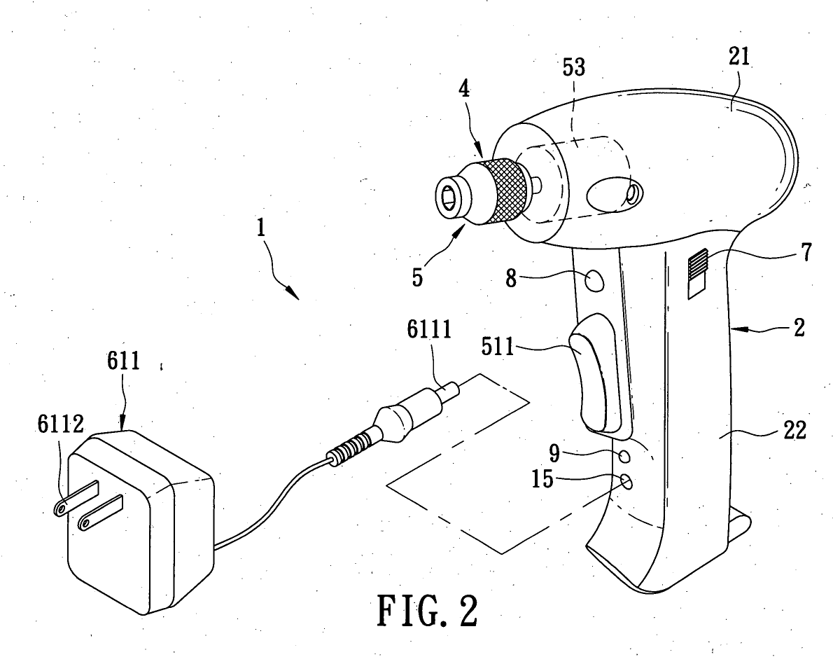

In particular, the power circuit 61 includes a charger circuit 612 and a direct current adapter 611. The charger circuit 612 is mounted in the top portion 21 of the tool housing 2 and is connected electrically to the battery contact set 62. The direct current adapter 611 is connected electrically to the charger circuit 612 and is adapted to receive the external power signal. More particularly, as best shown in FIG. 2, a socket 15 is mounted on the bottom portion 22 of the tool housing 2 and is connected electrically to the charger circuit 612 and the motor device 5. The direct current adapter 611 is disposed externally of the tool housing 2, and has a first end 6111 provided with a connector to connect removably with the socket 15, and a second end 6112 in the form of a plug to connect removably with an external power source (not shown). When the direct current adapter 611 connects the charger circuit 612 to the external power source, the electric power for operating the direct current motor 53 and the charging circuit 612 can be supplied accordingly.

In an alternative embodiment, the direct current adapter 611 is mounted in the top portion 21 of the tool housing 2, and is connected electrically to the charging circuit 612 and the motor device 5. The socket 15 is connected electrically to the direct current adapter 611. A power supply cable (not shown) has a first end provided with a connector to connect removably with the socket 15, and a second end in the form of a plug to connect removably with the external power source.

It is noted that the voltage amplifier 52 of the motor device 5 is a direct current-to-direct current converter, and is operable so as to increase the operating voltage provided to the direct current motor 53. With the increase in the operating voltage, the direct current motor 53 generates a larger torque output. This allows the direct current motor 53 to drive rotation of the tool bit holder 4 in a more stable manner.

The power tool 1 further includes a status indicator 9 that is mounted on the bottom portion 22 of the tool housing 2 and that is connected to and controlled by the charger circuit 612 so as to emit a visible light for indicating charging activity of the charger circuit 612.

The power tool 1 further includes a lamp 8 and a lamp switch 7. The lamp 8 is mounted on the bottom portion 22 of the tool housing 2 and is disposed adjacent to the tool bit holder 4. Preferably, the lamp 8 is a light-emitting diode (LED). The lamp switch 7 is mounted on the bottom portion 22 of the tool housing 2, and couples the lamp 8 to the power module 6. In this embodiment, the lamp switch 7 is operable so as to selectively make and break electrical connection between the lamp 8 and the power module 6. When the lamp switch 7 is operated such that an electrical connection is established between the lamp 8 and the power module 6, the lamp 8 produces light that is directed to the tool bit 100. As such, the power tool 1 of this invention is further operable as a flashlight.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A power tool comprising:
a tool housing provided with a battery chamber adapted to accommodate removably a rechargeable battery unit that includes at least a standard-sized battery cell;
a motor device mounted in said tool housing;
a tool bit holder coupled to and driven by said motor device; and
a power module coupled to said motor device for supplying electric power thereto, said power module including a battery contact set provided in said battery chamber and adapted to connect electrically with the rechargeable battery unit, and a power circuit connected electrically to said battery contact set,
said power circuit being responsive to an external power signal for permitting charging of the rechargeable battery unit through said battery contact set simultaneous with supply of the electric power to said motor device when the rechargeable battery unit is disposed in said battery chamber,
said power circuit permitting supply of the electric power to said motor device through the rechargeable battery unit in the absence of the external power signal.

2. The power tool as claimed in claim 1, wherein said power circuit includes a charger circuit connected electrically to said battery contact set.

3. The power tool as claimed in claim 2, wherein said power circuit further includes a direct current adapter adapted to receive the external power signal and connected electrically to said charger circuit.

4. The power tool as claimed in claim 2, further comprising a status indicator mounted on said tool housing and connected to and controlled by said charger circuit to indicate charging activity of said charger circuit.

5. The power tool as claimed in claim 1, wherein said motor device includes:
a direct current motor;
a voltage amplifier coupled electrically to said direct current motor; and
a motor controller coupled electrically to said voltage amplifier and said power module and operable so as to control direction of rotation of said direct current motor.

6. The power tool as claimed in claim 1, further comprising a lamp mounted on said tool housing and disposed adjacent to said tool bit holder, and a lamp switch mounted on said tool housing and operably associated with said lamp and said power module so as to selectively make and break electrical connection between said lamp and said power module.
